(19) United States
(12) Patent Application Publication
(10) Pub. No.: US 2015/0359046 A1
(43) Pub. Date: Dec. 10, 2015

(54) "2-IN-1 Toaster Oven" / "2-IN-1 Microwave Oven"

(71) Applicant: Younes Mohseni, Boca Raton, FL (US)

(72) Inventor: Younes Mohseni, Boca Raton, FL (US)

(21) Appl. No.: 14/297,600

(22) Filed: Jun. 5, 2014

(51) Int. Cl. H05B 6/64; A47J 37/06

(52) U.S. Cl. CPC H05B 6/647; H05B 6/6408; A47J 37/0629

(57) ABSTRACT

This design, “Multifunction Toaster Oven”/“Multifunction Microwave Oven-I”/“Multifunction Microwave Oven-II”, is a kitchen appliance which combines the functionality and ease of use of a 4-Slice “Toaster” and a “Toaster Oven”/“Microwave Oven”.

When added “heating elements” to a “Multifunction Microwave Oven-I”/“Multifunction Microwave Oven-II”, it becomes “Multifunction Microwave Oven-A”/“Multifunction Microwave Oven-B”.

Above designs make standard “Toaster”, “Toaster Oven” and “Microwave Oven” obsolete and, in addition to being aesthetically more appealing, they save money & energy, countertop & storage space and reduce clutter.

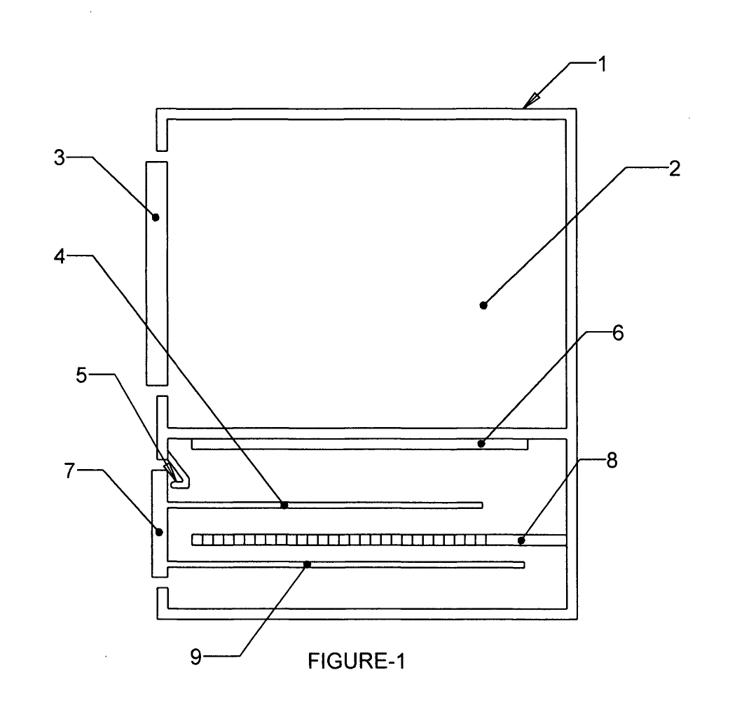

### FIG. 1:

(CONCEPT: Adding Toasting Function to a Toaster Oven/Microwave Oven)

1. Oven, 2. Oven Cavity, 3. Oven Door, 4. Rack (food holder), 5. Drawer Release Mechanism, 6. Top Heating Plate, 7. Toaster Drawer Assembly, 8. Bottom Heating Plate (bread crumbs pass through), 9. Tray (collects bread crumbs)

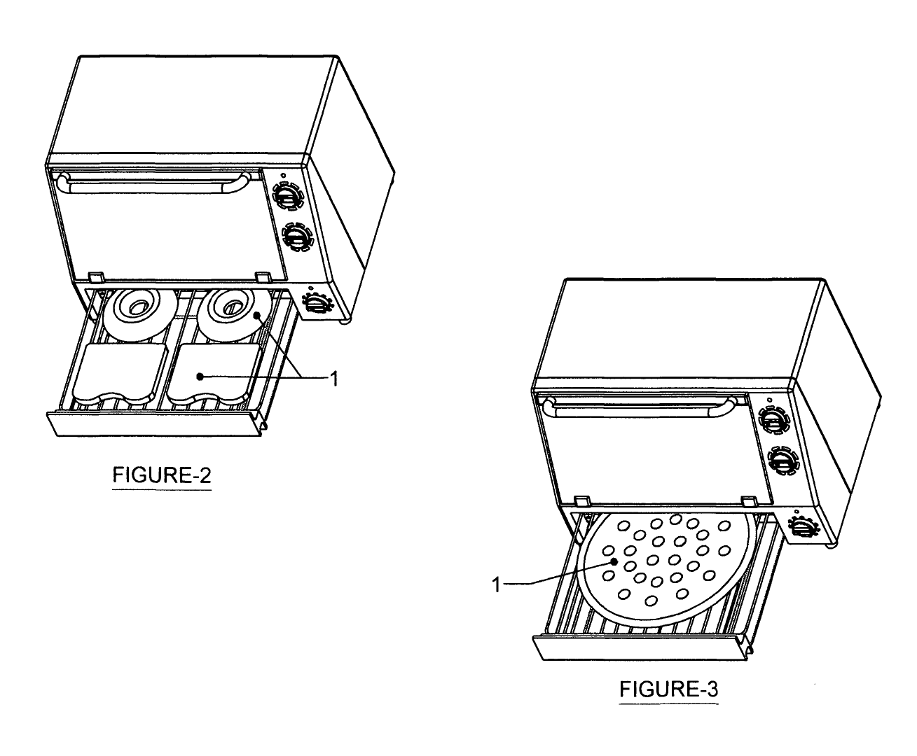

FIG. 2:

(ISOMETRIC VIEWS OF “2-IN-1 TOASTER OVEN” WITH DRAWER OPENED)

1. Toast/Bagel

FIG. 3:

(ISOMETRIC VIEW OF “2-IN-1 TOASTER OVEN” WITH DRAWER OPENED)

1. Pizza

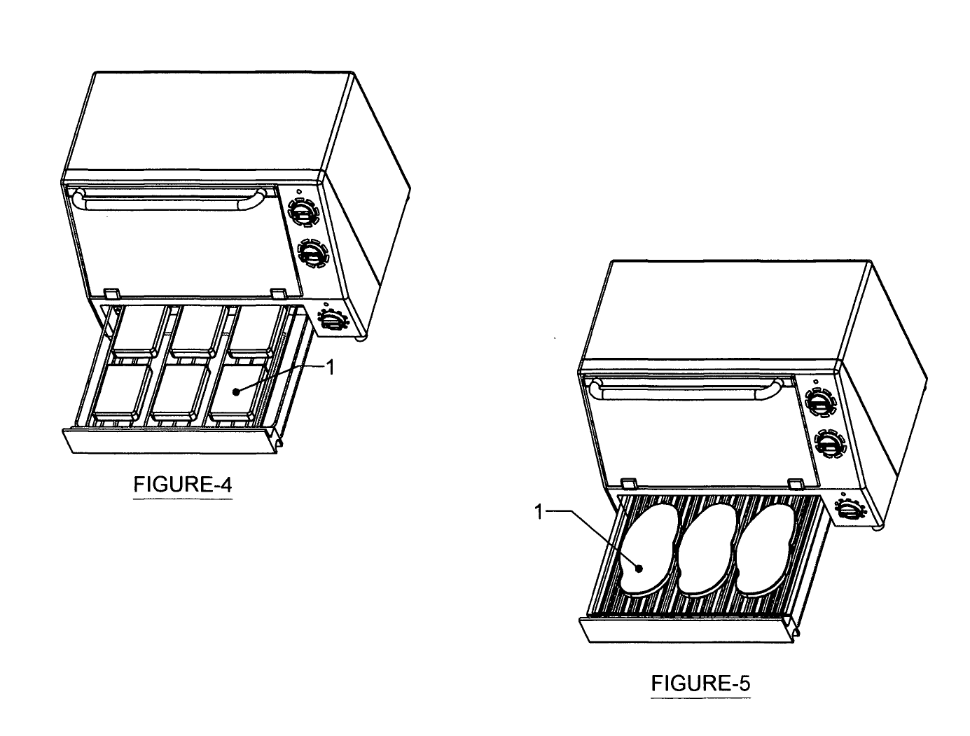

FIG. 4:

(ISOMETRIC VIEW OF “2-IN-1 TOASTER OVEN” WITH DRAWER OPENED)

1. Pastry

FIG. 5:

(ISOMETRIC VIEW OF “2-IN-1 TOASTER OVEN” WITH DRAWER OPENED)

1. Steak (cookie, hot dog, chicken nuggets, French fries, etc.)

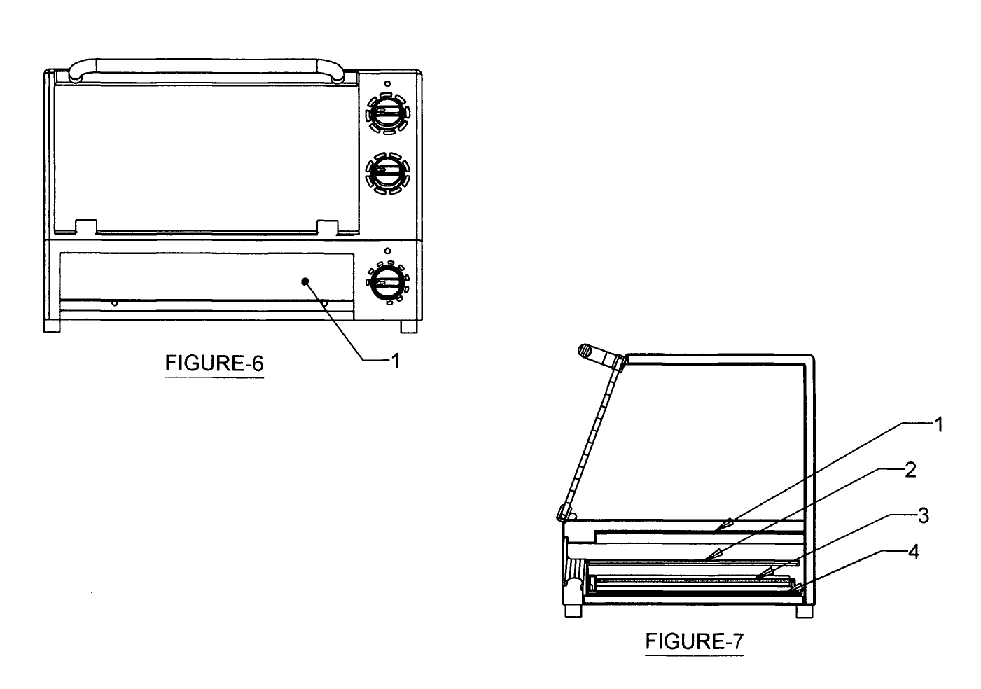

FIG. 6:

(FRONT VIEW OF “2-IN-1 TOASTER OVEN”)

1. On/Off Indicator Lights

2. Toaster Drawer Assembly

FIG. 7:

(CROSS SECTION OF “TOASTER ASSEMBLY” DISPLAYING TOAST CAVITY)

1. Top Heat Source

2. Rack

3. Bottom Heat Source

4. Tray

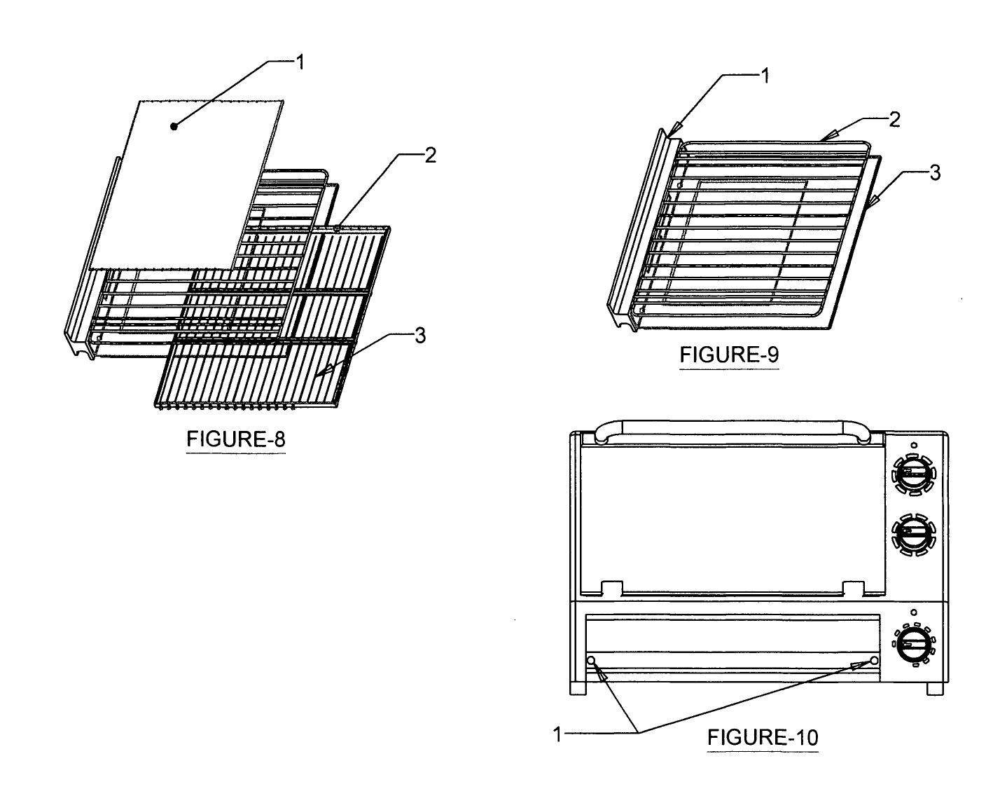

FIG. 8:

(ISOMETRIC VIEW OF “DRAWER ASSEMBLY” & EXPLODED VIEW OF “HEAT SOURCES”)

1. Top Heat Source (heating elements on opposite sides)

2. Bottom Heat Source (bread crumbs pass through and get collected by “Drawer Assembly Tray”)

3. Structural Supports

4. Heating Elements

FIG. 9:

(ISOMETRIC VIEW OF “DRAWER ASSEMBLY”)

1. Drawer Front Panel

2. Rack

3. Tray

FIG. 10:

(SIDE VIEW OF “2-IN-1 TOASTER OVEN”)

1. “¼ Turn” Screw

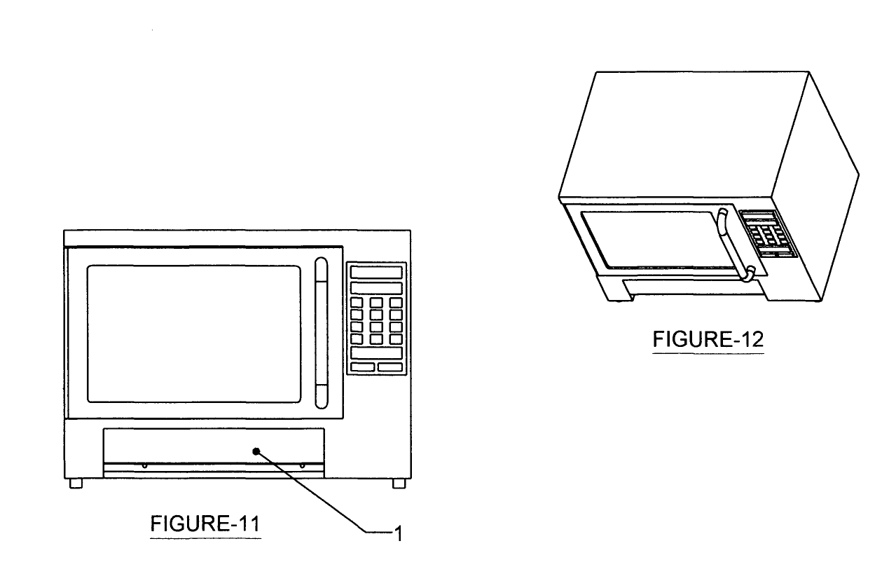

FIG. 11:

(FRONT VIEW OF “2-IN-1 TOASTER OVEN”. THE “DRAWER ASSEMBLY” IS REMOVED TO SHOW DRAWER RELEASE ARMS)

1. Drawer Release Arm

FIG. 12:

(FRONT VIEW OF COUNTERTOP “2-IN-1 MICROWAVE OVEN”)

1. Toaster Drawer Assembly

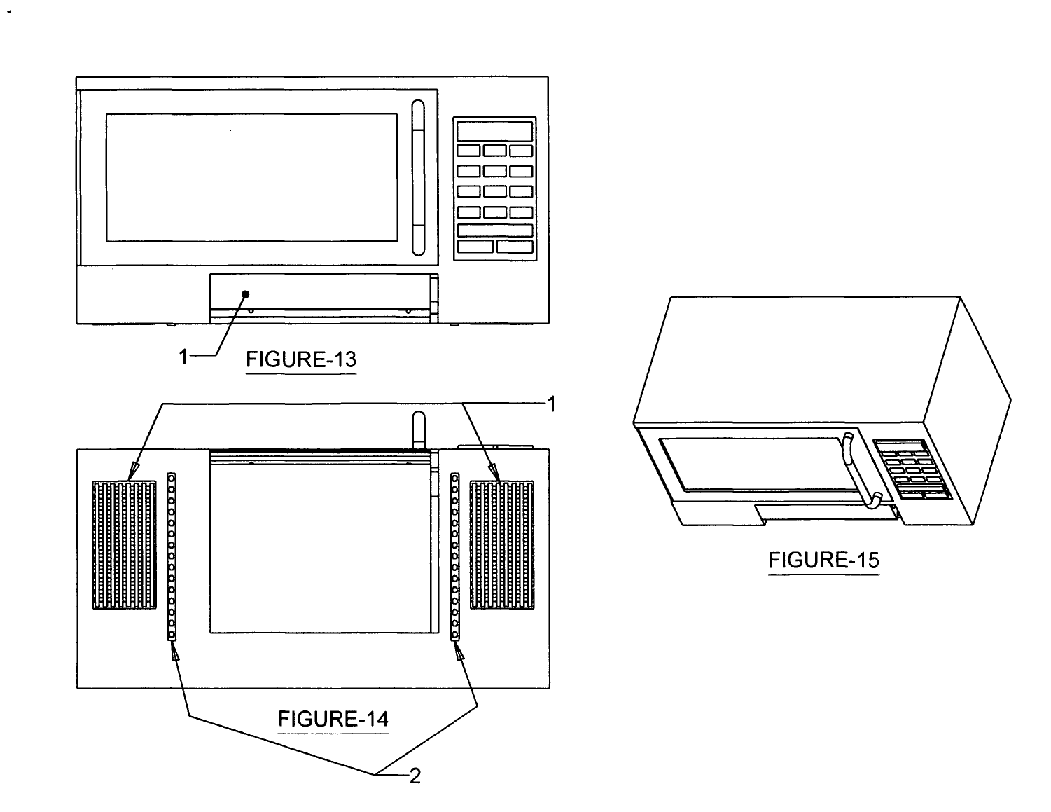

FIG. 13:

(ISOMETRIC VIEW OF COUNTERTOP “2-IN-1 MICROWAVE OVEN”)

FIG. 14:

(FRONT VIEW OF OVER-THE-RANGE “2-IN-1 MICROWAVE OVEN”)

1. Toaster Drawer Assembly

FIG. 15:

(BOTTOM VIEW OF OVER-THE-RANGE “2-IN-1 MICROWAVE OVEN”)

1. Filter

2. LED Lighting

FIG. 16:

(ISOMETRIC VIEW OF OVER-THE-RANGE “2-IN-1 MICROWAVE OVEN”)

### APPENDIX A (ADDITIONAL SPECIFICATION, DESCRIPTION & INFORMATION)

1. Existing materials, processes, manufacturing and technology are used to manufacture the “2-IN-1 Toaster Oven”/“2-IN-1 Microwave Oven”.

2. Adding toaster function to an existing platform, a current “Toaster Oven”/“Microwave Oven”, will add 2.75-3.00 inches to its height depending on configuration and manufacturing capabilities. This height increase creates a wide and large cavity inside the “Toaster Assembly” and is irrespective of the unit's width and/or depth. Re-designing the microwave ovens with intention to include “Toaster Assembly” will reduce these numbers slightly.

The width and depth of the unit are determined mainly by the size of the pizza to be placed inside the toaster cavity of the “2-IN-1 Toaster Oven”/“2-IN-1 Microwave Oven”. For a 12-inch pizza, the depth and width of the “2-IN-1 Toaster Oven” will be approximately 14 inches and 18 inches respectively.

3. The tray in “Drawer Assembly” prevents the “Drawer Assembly” to be taken out completely during the operation from the unit, similar to any cabinet drawer or rack inside a conventional large oven. To remove the “Drawer Assembly” from the unit, for cleaning purposes, the “Drawer Assembly” needs to be slightly lifted upward. This role can be assigned to the rack instead of the tray.

4. Two spring-loaded, time-activated rods will open the “Drawer Assembly” by pushing it out slightly at the end of the cycle, when the unit shuts down automatically.

This can be an optional feature as the unit automatically shuts off and a “ding/beep” sound let the consumer know that the toasting/cooking is done.

5. The tray in “Drawer Assembly” can be attached by two (minimum) “¼ turn” screws. It can be detached and attached quickly and easily, with or without a tool, by the consumer for cleaning purposes.

The other option, although not desirable, is to let the tray be un-attached, i.e. free float as a single part, and rest on the floor of the unit. In this case, the bread crumbs will fall on the countertop surface while the “Drawer Assembly” is open and the food items are handled.

6. The three knobs can be replaced by a digital control panel or a digital control panel and a dial knob.

7. If the “toaster” function of the “2-IN-1 Toaster Oven”/“2-IN-1 Microwave Oven” is incorporated in a microwave oven equipped with “heating element for broiling”, the unit will eliminate the need for “Toaster” and “Toaster Oven” all together, making it a “3-in-1”, Toaster/Toaster Oven/Microwave Oven, appliance.

### APPENDIX B (ADVANTAGES)

The advantages of using the “2-IN-1 Toaster Oven”/“2-IN-1 Microwave Oven” in place of a “Toaster Oven”/“Microwave Oven” and a “Toaster” are:

### 1. Initial Saving

The cost of owning a “2-IN-1 Toaster Oven”/“2-IN-1 Microwave Oven”, is less than owning a “Toaster” and a “Toaster Oven”/“Microwave Oven”.

### 2. Space Saving

The “2-IN-1 Toaster Oven”/“2-IN-1 Microwave Oven” eliminates the need for a separate “Toaster” therefore saves valuable kitchen countertop space, especially in dwellings with small kitchens or dormitories.

### 3. Reduced Clutter

The “2-IN-1 Toaster Oven”/“2-IN-1 Microwave Oven” reduces the kitchen clutter by eliminating a “Toaster”.

### 4. Time And Electricity Saving

The toaster cavity of the “2-IN-1 Toaster Oven”/“2-IN-1 Microwave Oven” is small therefore eliminates the “Preheat” requirement and toast faster than a “Toaster Oven”. This saves time and electricity.

### 5. Versatility

In addition to toasting, the toaster cavity of the “2-IN-1 Toaster Oven”/“2-IN-1 Microwave Oven” bakes and broils food items such as pizza, steak, hot dog, cookies, chicken nuggets, French fries, etc. and it does it faster than a regular conventional or “Toaster Oven”.

### 6. Even Cooking

Unlike a “Toaster Oven” which has concentrated heat sources, the heat generated by heat sources on top and bottom of the toaster cavity of the “2-IN-1 Toaster Oven”/“2-IN-1 Microwave Oven” is distributed over large area and covers the entire food item. As a result any food item is cooked more evenly in toaster cavity of the “2-IN-1 Toaster Oven”/“2-IN-1 Microwave Oven”.

### 7. Appearance

The “2-IN-1 Toaster Oven”/“2-IN-1 Microwave Oven” is aesthetically more appealing than a “Toaster” and a “Toaster Oven”/“Microwave Oven” placed next to each other.

All design notes in Appendix A, sketches and drawings presented here including, but not limited to:

1. Design Concept (FIG. 1)

2. “Drawer Assembly” (FIG. 9)

3. “Drawer Assembly” Components:
a. Drawer “Front Panel” (FIG. 9, ITEM-1)
b. Drawer “Rack” (FIG. 9, ITEM-2)
c. Drawer “Tray” (FIG. 9, ITEM-3)

4. “Heat Source Top” (FIG. 8, ITEM-1)

5. “Heat Source Bottom” (FIG. 8, ITEM-2)

6. “Drawer Assembly” release mechanism and locations (FIG. 10, ITEM-1)

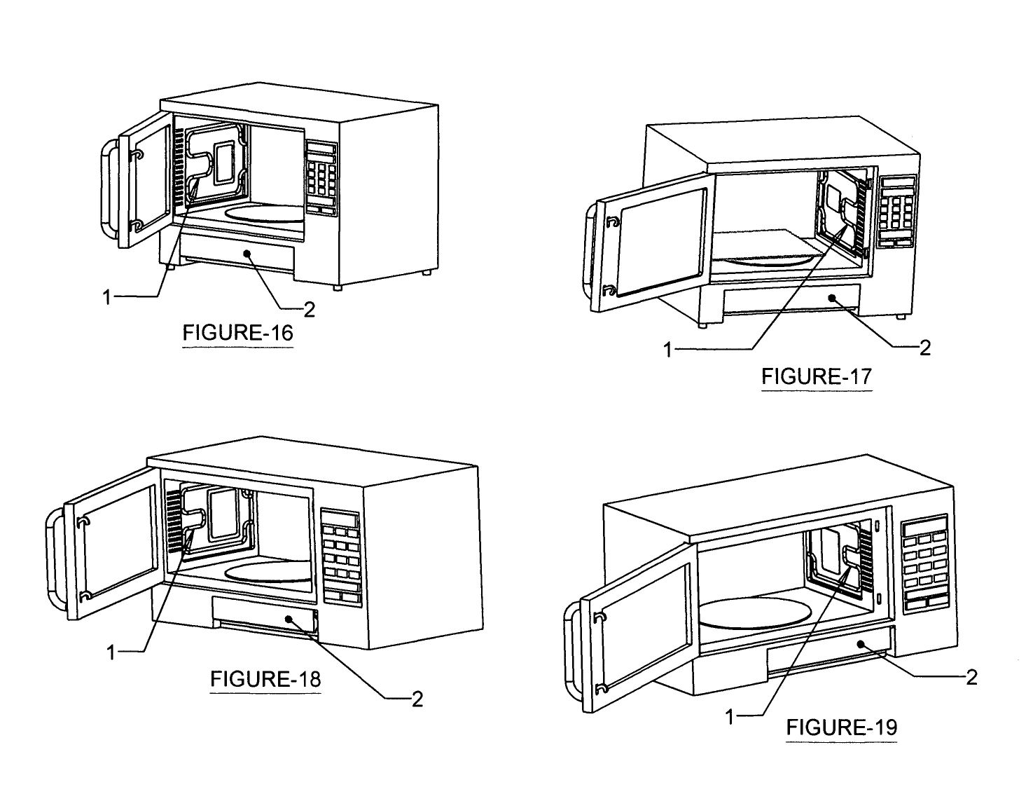

7. Side wall placement of heating elements in both Countertop and Over-The-Range Microwave Ovens to create “Multifunction Microwave Oven-A” and “Multifunction Microwave Oven-B” (FIGS. 16, 17, 18 and 19, ITEM-1)
